(19) United States
(12) Patent Application Publication
(10) Pub. No.: US 2025/0042797 A1
(43) Pub. Date: Feb. 6, 2025

(54) APPARATUS CONFIGURED TO TREAT WASTEWATER AND METHOD OF TREATING WASTEWATER

(71) Applicant: SAMSUNG ELECTRONICS CO., LTD., Suwon-si (KR)

(72) Inventors: Daeseon Park, Suwon-si (KR); Seoktae Kang, Daejeon (KR); David Kim, Suwon-si (KR); Junho Kim, Daejeon (KR); Inseo Yoon, Suwon-si (KR); Hansol Jang, Suwon-si (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 18/734,543

(22) Filed: Jun. 5, 2024

(30) Foreign Application Priority Data
Aug. 4, 2023 (KR) 10-2023-0102289
Sep. 27, 2023 (KR) 10-2023-0131173

(51) Int. Cl. C02F 9/00; C02F 1/00; C02F 1/02; C02F 1/44; C02F 1/70; C02F 101/14; C02F 101/16; C02F 103/34

(52) U.S. Cl. CPC C02F 9/00; C02F 1/008; C02F 1/02; C02F 1/44; C02F 1/705; C02F 2101/14; C02F 2101/16; C02F 2103/346; C02F 2209/02

(57) ABSTRACT

An apparatus configured to treat wastewater includes a first water tank configured to store wastewater, a second water tank configured to store absorbent liquid, and a membrane assembly including a membrane including holes, the membrane assembly configured to receive the wastewater from the first water tank and the absorbent liquid from the second water tank, where the membrane assembly is further configured to allow materials to move between the wastewater and the absorbent liquid through the holes, and where, in the membrane assembly, a temperature of the absorbent liquid is different from a temperature of the wastewater.

### CROSS-REFERENCE TO RELATED APPLICATIONS

This application is based on and claims priority under 35 U.S.C. § 119 to Korean Patent Application No. 10-2023-0131173, filed on Sep. 27, 2023, in the Korean Intellectual Property Office, and Korean Patent Application No. 10-2023-0102289, filed on Aug. 4, 2023, in the Korean Intellectual Property Office, the disclosures of which are incorporated by reference herein in their entireties.

### BACKGROUND

Example embodiments of the disclosure relate to an apparatus configured to treat wastewater and a method of treating wastewater, and more particularly, to a wastewater treating apparatus including a membrane assembly and a method of treating wastewater.

As industries become more sophisticated and diversified, various pollutants are being emitted from industrial facilities. For example, because wastewater containing hydrogen peroxide (H₂O₂), ammonia (NH₃), and/or hydrogen fluoride (HF) used in a semiconductor manufacturing process causes corrosion of a treating device, ecotoxicity, and/or environmental pollution, there is a need to treat and recycle the wastewater in an environmentally friendly manner.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a waste treating apparatus and a method of treating wastewater, which may environmentally treat and recycle wastewater including hydrogen peroxide, ammonia, and/or hydrogen fluoride.

Additional aspects will be set forth in part in the description which follows and, in part, will be apparent from the description, or may be learned by practice of the presented embodiments.

According to an aspect of an example embodiment, an apparatus configured to treat wastewater may include a first water tank configured to store wastewater, a second water tank configured to store absorbent liquid, and a membrane assembly including a membrane including holes, the membrane assembly configured to receive the wastewater from the first water tank and the absorbent liquid from the second water tank, where the membrane assembly is further configured to allow materials to move between the wastewater and the absorbent liquid through the holes, and where, in the membrane assembly, a temperature of the absorbent liquid is different from a temperature of the wastewater.

According to an aspect of an example embodiment, an apparatus configured to treat wastewater may include a first water tank configured to store wastewater, a second water tank configured to store absorbent liquid, at least one membrane assembly including a membrane including holes, the at least one membrane assembly configured to receive the wastewater from the first water tank the absorbent liquid from the second water tank, where the at least one membrane assembly is further configured to allow materials to move between the wastewater and the absorbent liquid through the holes, a first temperature adjuster configured to change a temperature of the wastewater, a second temperature adjuster configured to change a temperature of the absorbent liquid, and a controller configured to control the temperature of the absorbent liquid to be higher than the temperature of the wastewater by controlling at least one of the first temperature adjuster and the second temperature adjuster.

According to an aspect of an example embodiment, a method of treating wastewater using a membrane assembly may include measuring a temperature of wastewater and a temperature of absorbent liquid, determining a mole fraction of water in the wastewater and a mole fraction of water in the absorbent liquid, determining a difference between a vapor pressure of the wastewater and a vapor pressure of the absorbent liquid based on the mole fraction of water in the wastewater and the mole fraction of water in the absorbent liquid, determining the temperature for absorbent liquid based on the difference between the vapor pressure of the wastewater and the vapor pressure of the absorbent liquid, and raising the temperature of the absorbent liquid above the temperature of the wastewater based on the determined temperature for the absorbent liquid.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a block diagram of a wastewater treating apparatus according to one or more example embodiments;

FIG. 2 is a cross-sectional view of a hydrogen peroxide treating tank according to one or more example embodiments;

FIG. 3 is a cross-sectional view of a membrane assembly according to one or more example embodiments;

FIG. 4 is a flowchart of a method of treating wastewater, according to one or more example embodiments;

FIG. 5 is a diagram of the flows of wastewater and absorbent liquid in a membrane assembly according to one or more example embodiments;

FIG. 6 is a diagram of the flow of water vapor in holes of a membrane according to one or more example embodiments;

FIG. 7 is a diagram of a wastewater treating apparatus according to one or more example embodiments;

FIG. 8 is a diagram of a wastewater treating apparatus according to one or more example embodiments;

FIG. 9 is a diagram of a wastewater treating apparatus according to one or more example embodiments; and

FIG. 10 is a graph showing the results of experiments using a method of treating wastewater, according to one or more example embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

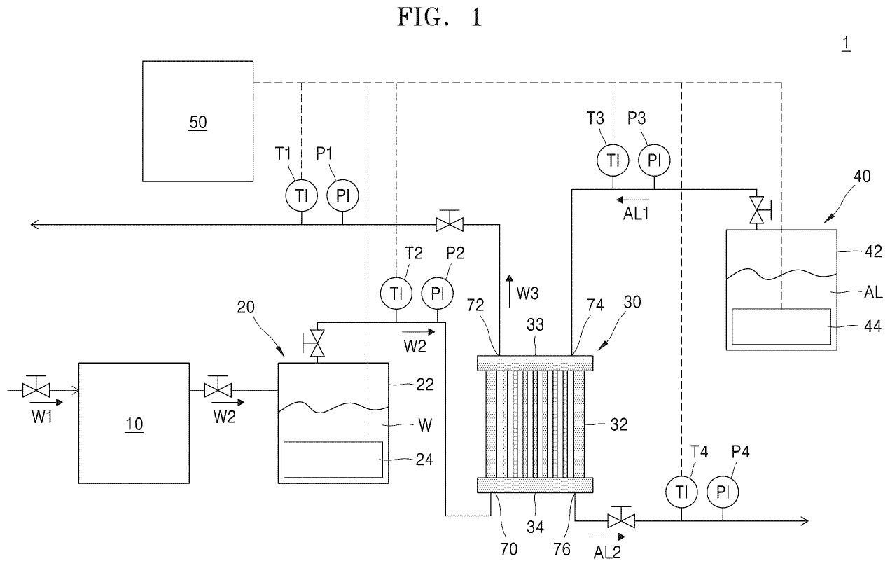

FIG. 1 is a block diagram of a wastewater treating apparatus according to one or more example embodiments.

Referring to FIG. 1, a wastewater treating apparatus 1 may include a hydrogen peroxide treating tank 10, a first water tank 20, a membrane assembly 30, a second water tank 40, and a controller 50. The wastewater treating apparatus 1 may remove impurities included in wastewater W. For example, the wastewater treating apparatus 1 may remove hydrogen peroxide (H₂O₂), ammonia (NH₃) and/or hydrogen fluoride (HF), which are included in the wastewater W. For example, the wastewater W may be generated during a semiconductor manufacturing process, such as, a diffusion process, etching process, or cleaning process using ammonia and/or fluorine (F).

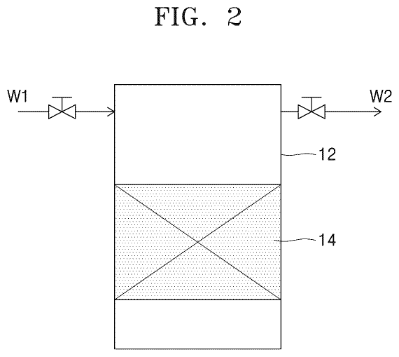

The hydrogen peroxide treating tank 10 may remove hydrogen peroxide included in the wastewater W. Descriptions of the hydrogen peroxide treating tank 10 are provided with reference to FIG. 2.

FIG. 2 is a cross-sectional view of a hydrogen peroxide treating tank according to one or more example embodiments. The hydrogen peroxide treating tank of FIG. 2 is described with reference to FIG. 1.

Referring to FIG. 2, the hydrogen peroxide treating tank 10 may include a housing 12 and a filter 14. The housing 12 may provide a space for storing wastewater W. For brevity, wastewater W flowing into the hydrogen peroxide treating tank 10 may be referred to as first wastewater W1, and wastewater W discharged from the hydrogen peroxide treating tank 10 may be referred to as second wastewater W2. A concentration of hydrogen peroxide in the second wastewater W2 may be lower than a concentration of hydrogen peroxide in the first wastewater W1. For example, the second wastewater W2 may be pretreated wastewater W.

The filter 14 may remove hydrogen peroxide included in the wastewater W. For example, the filter 14 may include a carrier. The carrier may promote a hydrogen peroxide decomposition reaction. For example, the carrier may include manganese dioxide and/or activated carbon. The carrier may include a catalyst. For example, the catalyst may include an inorganic metal compound, such as iron (Fe), copper (Cu), and/or nickel (Ni). Hydrogen peroxide included in the wastewater W may decompose due to a reaction according to Equation (1).

$${H}_{2} {O}_{2} {\to }^{catalyst} {H}_{2} O + \frac{1}{2} {O}_{2} \qquad ( 1 )$$

The catalyst may increase a reaction rate of the reaction according to Equation (1). Accordingly, the hydrogen peroxide treating tank 10 may include the catalyst, and thus, a decomposition rate of hydrogen peroxide in the wastewater W may increase. That is, the catalyst may promote a hydrogen peroxide decomposition reaction.

Referring back to FIG. 1, the wastewater W from which at least part of hydrogen peroxide has been removed may flow into the first water tank 20. The first water tank 20 may include a housing 22 and a first temperature adjuster 24. The first water tank 20 may store wastewater W including impurities. For example, the wastewater W may include ammonia and/or hydrogen fluoride.

Although the hydrogen peroxide treating tank 10 is illustrated as being at a front end of the first water tank 20 in FIG. 1, the disclosure is not limited thereto. In some embodiments, the hydrogen peroxide treating tank 10 may be at a rear end of the first water tank 20.

The first water tank 20 may be at a rear end of the hydrogen peroxide treating tank 10 and a front end of the membrane assembly 30. After the second wastewater W2 flows into the first water tank 20, the second wastewater W2 may be discharged from the first water tank 20. The housing 22 may provide a space for storing the wastewater W. The first temperature adjuster 24 may change a temperature of the wastewater W. For example, the first temperature adjuster 24 may include a heater and/or a cooler.

Although the first temperature adjuster 24 is illustrated as being inside the first water tank 20 in FIG. 1, the disclosure is not limited thereto. For example, the first temperature adjuster 24 may be in a pipe between the first water tank 20 and the membrane assembly 30. That is, the first temperature adjuster 24 may be formed separately from the first water tank 20.

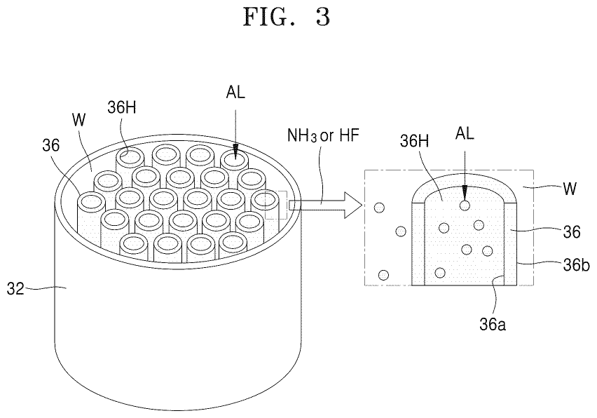

The membrane assembly 30 may be connected to the first water tank 20 and the second water tank 40 such that the wastewater W and absorbent liquid AL pass through the membrane assembly 30. That is, the membrane assembly 30 may be configured to receive the wastewater W from the first water tank 20 and receive the absorbent liquid AL from the second water tank 40. The membrane assembly 30 may separate, recover, and discharge impurities from the wastewater W supplied from the first water tank 20. Detailed descriptions of the membrane assembly 30 are provided with reference to FIG. 3.

FIG. 3 is a cross-sectional view of a membrane assembly according to one or more example embodiments. The membrane assembly of FIG. 3 is described with reference to FIG. 1.

Referring to FIG. 3, a membrane assembly 30 may include a housing 32 including an upper portion 33 and a lower portion 34, and a membrane 36 located in the housing 32. The membrane 36 may include a plurality of holes 36H, and a material may move through the holes 36H between wastewater W and absorbent liquid AL. The membrane assembly 30 may be at a rear end of a first water tank 20 and a rear end of the second water tank 40.

An inlet port 70 and an outlet port 72 for the wastewater W may be respectively in the lower portion 34 and the upper portion 33 of the housing 32 of the membrane assembly 30. An inlet port 74 and an outlet port 76 for the absorbent liquid AL may be respectively in the upper portion 33 and the lower portion 34 of the housing 32 of the membrane assembly 30. The outlet port 72 for the wastewater W and the inlet port 74 for the absorbent liquid AL are illustrated as being in the upper portion 33, and the inlet port 70 for the wastewater W and the outlet port 76 for the absorbent liquid AL are illustrated as being in the lower portion 34 in FIG. 1, but the disclosure is not limited thereto. In some embodiments, the inlet port 70 for the wastewater W and the outlet port 76 for the absorbent liquid AL may be in the upper portion 33, and the outlet port 72 for the wastewater W and the inlet port 74 for the absorbent liquid AL may be in the lower portion 34.

The inlet port 70 for the wastewater W and the outlet port 76 for the absorbent liquid AL may be adjacent to each other such that a direction in which the wastewater W moves may be set to be different from a direction in which the absorbent liquid AL moves into the membrane assembly 30. In some embodiments, the inlet port 70 for the wastewater W and the inlet port 74 for the absorbent liquid AL may be adjacent to each other.

The membrane 36 may provide a path through which materials move between the wastewater W and the absorbent liquid AL. The membrane 36 may have an inner side surface 36a and an outer side surface 36b corresponding to each hole 36H. The absorbent liquid AL may contact the inner side surface 36a, and the wastewater W may contact the outer side surface 36b. Ammonia and/or hydrogen fluoride, which are impurities in the wastewater W, may move through the holes 36H to the absorbent liquid AL. Accordingly, the absorbent liquid AL may include a material with high solubility in impurities.

For example, the membrane 36 may include a material that is acid-resistant and hydrophobic. For example, the membrane 36 may include tetrafluroethylene-hexafluoropropylene (FEP), perfluoroalkyl alkylvinyl-ether (PFA), ethylene-tetrafluoroethylene (ETFE), polyvinylidene fluoride (PVDF), polytetrafluoroethylene (PTFE), polyethylene (PE), polypropylene (PP), polyether ether ketone (PEEK), polyarylsulfone (PSU), polyethersulphone (PES), polyimide (PI), and/or polybenzimidazole (PBI).

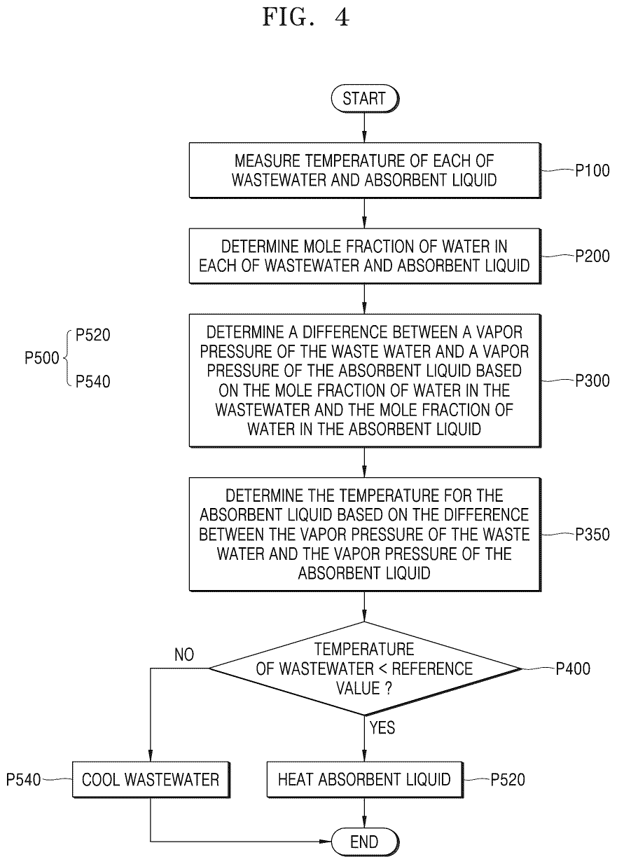

However, not only impurities but also water vapor may move from the wastewater W to the absorbent liquid AL through the membrane 36. Because a mole fraction of water in the wastewater W is higher than a mole fraction of water in the absorbent liquid AL, water vapor molecules may move from the wastewater W to the absorbent liquid AL. To compensate for the movement of water vapor molecules, a temperature of the absorbent liquid AL may be raised above a temperature of the wastewater W. A process of measuring the temperature of the absorbent liquid AL to compensate for the movement of water vapor due to a difference between the mole fraction of water in the wastewater W and the mole fraction of water in the absorbent liquid AL is described in detail with reference to FIGS. 4 to 6.

For brevity, wastewater W flowing into the membrane assembly 30 may be referred to as second wastewater W2, and wastewater W discharged from the membrane assembly 30 may be referred to as third the wastewater W3. A concentration of impurities in the third wastewater W3 may be lower than a concentration of impurities in the second wastewater W2. Also, absorbent liquid AL flowing into the membrane assembly 30 may be referred to as first absorbent liquid AL1, and absorbent liquid discharged from the membrane assembly 30 may be referred to as second absorbent liquid AL2.

The second absorbent liquid AL2 may flow into the second water tank 40. That is, the second absorbent liquid AL2 may be recycled again as the first absorbent liquid AL1. Also, the third wastewater W3 may flow into the hydrogen peroxide treating tank 10 and/or the first water tank 20. That is, the third wastewater W3 may be recycled again as the first wastewater W1 and/or the second wastewater W2.

Referring back to FIG. 1, the second water tank 40 may include a housing 42 and a second temperature adjuster 44. The second water tank 40 may store absorbent liquid AL configured to absorb impurities of the wastewater W. When the wastewater W is acidic, the absorbent liquid AL may be basic. Conversely, when the wastewater W is basic, the absorbent liquid AL may be acidic. For example, when the absorbent liquid AL is acidic, the absorbent liquid AL may include sulfuric acid (H₂SO₄), hydrochloric acid (HCl), nitric acid (HNO₃), and/or acetic acid (CH₃COOH). When the absorbent liquid AL is basic, the absorbent liquid AL may include sodium hydroxide (NaOH) and/or potassium hydroxide (KOH).

The second temperature adjuster 44 may change a temperature of the absorbent liquid AL. The second temperature adjuster 44 may heat the absorbent liquid AL such that the absorbent liquid AL has a higher temperature than the wastewater W. For example, the second temperature adjuster 44 may include a heater and/or cooler.

Although the second temperature adjuster 44 is illustrated as being in the second water tank 40 in FIG. 1, the disclosure is not limited thereto. For example, the second temperature adjuster 44 may be in a pipe between the membrane assembly 30 and the second water tank 40. That is, the second temperature adjuster 44 may be formed separately from the second water tank 40.

For brevity, absorbent liquid AL flowing out of the second water tank 40 may be referred to as first absorbent liquid AL1, and absorbent liquid AL discharged from the membrane assembly 30 may be referred to as second absorbent liquid AL2. The second absorbent liquid AL2 may further include impurities diffused from the wastewater W.

A first thermometer T1 and a first pressure gauge P1 may be at a front end of the inlet port 70 for the wastewater W, and a second thermometer T2 and a second pressure gauge P2 may be at a rear end of the outlet port 72 for the wastewater W. Also, a third thermometer T3 and a third pressure gauge P3 may be at a front end of the inlet port 74 for the absorbent liquid AL, and a fourth thermometer T4 and a fourth pressure gauge P4 may be at a rear end of the outlet port 76 for the absorbent liquid AL. Each of the first to fourth thermometers T1, T2, T3, and T4 may measure a temperature at each position, and each of the first to fourth pressure gauges P1, P2, P3, and P4 may measure a pressure at each position.

The wastewater treating apparatus 1 may further include a flow meter. The first to fourth pressure gauges P1, P2, P3, and P4 and the flow meter may be used to evaluate whether the wastewater treating apparatus 1 is normally operating and/or damaged.

The controller 50 may adjust the temperature of the wastewater W and the temperature of the absorbent liquid AL. The controller 50 may be connected to the first to fourth thermometers T1, T2, T3, and T4, the first temperature adjuster 24, and the second temperature adjuster 44 and adjust the temperature of the wastewater W and the temperature of the absorbent liquid AL. The temperature of the wastewater W in the membrane assembly 30 may be measured as an average of temperatures of the wastewater W that are respectively measured by the first thermometer T1 and the second thermometer T2, and the temperature of the absorbent liquid AL in the membrane assembly 30 may be measured as an average of temperatures of the absorbent liquid AL that are respectively measured by the third thermometer T3 and the fourth thermometer T4. A method by which the controller 50 controls the first temperature adjuster 24 and the second temperature adjuster 44 is described in detail with reference to FIGS. 4 to 6.

The controller 50 may be implemented as hardware, firmware, software, or any combination thereof. For example, the controller 50 may include a computing device, such as a workstation computer, a desktop computer, a laptop computer, and a tablet computer. For example, the controller 50 may include a memory device, such as read-only memory (ROM) and random access memory (RAM), and a processor (e.g., a microprocessor, a central processing unit (CPU), and a graphics processing unit (GPU)) configured to perform predetermined operations and algorithms. In addition, the controller 50 may include a receiver and a transmitter configured to receive and transmit electrical signals from/to elements of the wastewater treating apparatus 1.

In a conventional wastewater treating apparatus, in a process of diffusing impurities of wastewater into absorbent liquid, a relatively large amount of water vapor may move from the wastewater to the absorbent liquid, thus resulting in a relatively large reduction in the concentration of the absorbent liquid and a relatively large increase in the volume of the absorbent liquid.

Conversely, in the wastewater treating apparatus 1 according to one or more example embodiments, the temperature of the absorbent liquid AL may be set to be higher than the temperature of the wastewater W, and thus, the movement of water vapor from the wastewater W to the absorbent liquid AL may be relatively reduced. Accordingly, a concentration of the absorbent liquid AL may be relatively slightly reduced, and a volume of the absorbent liquid AL may be relatively slightly increased, and thus, the reliability of the wastewater treating apparatus 1 may increase.

FIG. 4 is a flowchart of a method of treating wastewater, according to one or more example embodiments. The method of FIG. 4 is described with reference to FIGS. 1 to 3. FIG. 4 illustrates an example of a method of processing wastewater when materials are exchanged between wastewater W and absorbent liquid AL in a membrane assembly 30.

Referring to FIG. 4, a temperature of each of the wastewater W and the absorbent liquid AL may be measured in operation P100. As described above, the temperature of the wastewater W may be determined as an average of temperatures of the wastewater W that are respectively measured by a first thermometer T1 and a second thermometer T2. Also, the temperature of the absorbent liquid AL may be measured as an average of temperatures of the absorbent liquid AL that are respectively measured by a third thermometer T3 and a fourth thermometer T4.

Afterwards, a mole fraction of water in each of the wastewater W and the absorbent liquid AL may be determined in operation P200.

The mole fraction of water in each of the wastewater W and the absorbent liquid AL may be determined based on a concentration of salt in each of the wastewater W and the absorbent liquid AL. When the wastewater W flows into a first water tank 20, the concentration of salt in the wastewater W may be measured. Also, when the absorbent liquid AL flows into the second water tank 40, the concentration of salt in the absorbent liquid AL may be measured.

More specifically, when the concentration of salt is measured, a mole number of salt in a water solution may be measured. Thereafter, a mole number of water may be measured, and a mole fraction of water may be measured based on the mole number of salt and the mole number of water.

Subsequently, a difference between a vapor pressure of the wastewater and a vapor pressure of the absorbent liquid based on the mole fraction of water in the wastewater and the mole fraction of water in the absorbent liquid may be determined in operation P300. The temperature of each of the wastewater W and/or the absorbent liquid AL may also be determined in operation P300. When the temperature of the wastewater W is equal to the temperature of the absorbent liquid AL, a difference between the vapor pressure of the wastewater W and the vapor pressure of the absorbent liquid AL may be expressed as shown in Equation (2):

$$Δ P = {P}_{w a t e r} ( {X}_{W} - {X}_{A L} ) \qquad ( 2 )$$

where ΔP is the difference between the vapor pressure of the wastewater W and the vapor pressure of the absorbent liquid AL, P_{water} is a vapor pressure of pure water, X_{W} is the mole fraction of water in the wastewater W, and X_{AL} is the mole fraction of water in the absorbent liquid AL.

In general, the mole fraction of water in the wastewater W may be higher than the mole fraction of water in the absorbent liquid AL. Accordingly, to compensate for the movement of water vapor due to a difference in the mole fraction, the temperature of the absorbent liquid AL may be raised above the temperature of the wastewater W. When the temperature of the absorbent liquid AL becomes higher than the temperature of the wastewater W, the difference between the vapor pressure of the wastewater W and the vapor pressure of the absorbent liquid AL may be reduced. A difference between the vapor pressure of the wastewater W and the vapor pressure of the absorbent liquid AL, which is obtained considering both the temperature of the wastewater W and the temperature of the absorbent liquid AL, may be expressed as in Equation (3):

$$Δ P = {P}_{w a t e r} ( {T}_{W} ) {X}_{W} - {P}_{w a t e r} ( {T}_{A L} ) {X}_{A L} \qquad ( 3 )$$

where ΔP is a difference between the vapor pressure of the wastewater W and the vapor pressure of the absorbent liquid AL, P_{water} is a vapor pressure of pure water, X_{W} is a mole fraction of water in the wastewater W, T_{W} is the temperature of the wastewater W, and T_{AL} is the temperature of the absorbent liquid AL.

Here, a vapor pressure is a function of a temperature, and a relationship between the vapor pressure and the temperature is shown as in Equation (4):

$${P}_{water} ( T ) = 1 {0}^{( 8.071 \; 31 - \frac{A}{B + T} )} \qquad ( 4 )$$

where P_{water}(T) is a vapor pressure at a temperature T, each of A and B is a constant, A is 1730.63, and B is 233.426.

In operation P350, the temperature for absorbent liquid based on the difference between the vapor pressure of the wastewater and the vapor pressure of the absorbent liquid may be determined. By combining Equation (3) and Equation (4), the temperature of the absorbent liquid AL, which may compensate for the difference between the vapor pressure of the wastewater W and the vapor pressure of the absorbent liquid AL according to the difference in mole fraction of water, may be expressed as in Equation (5):

$${T}_{A L} = \frac{- A + B \times log ( \frac{{X}_{A L}}{{X}_{W}} ) + \frac{A \times B}{B + {T}_{W}}}{- \frac{A}{B + {T}_{W}} - log \frac{{X}_{A L}}{{X}_{W}}} \qquad ( 5 )$$

where T_{AL} is a temperature of the absorbent liquid AL, T_{W} is a temperature of the wastewater W, X_{W} is a mole fraction of water in the wastewater W, T_{W} is a temperature of the wastewater W, each of A and B is a constant, A is 1730.63, and B is 233.426.

That is, when the temperature of the absorbent liquid AL is set to the result of Equation (5), the movement of water vapor due to a difference between the mole fraction of water in the wastewater W and the mole fraction of water in the absorbent liquid AL may be compensated for.

As an example, Equation (5) shows a process of determining the temperature of the absorbent liquid AL when the temperature of the wastewater W is given. However, on the contrary, a process of determining the temperature of the wastewater W may be performed when the temperature of the absorbent liquid AL is given.

From Equation (5), the temperature of the absorbent liquid AL and/or the temperature of the wastewater W, which may compensate for the difference between the vapor pressure of the wastewater W and the vapor pressure of the absorbent liquid AL, may be obtained. Specifically, the temperature of the absorbent liquid AL and/or the temperature of the wastewater W may respectively refer to temperatures of the absorbent liquid AL and/or the wastewater W, which contact the holes 36H of the membrane 36. During implementation, the temperature of the absorbent liquid AL and/or the temperature of the wastewater W inside the hole 36H may be different from a theoretical value (e.g., an average of temperatures of a front end and a rear end of the membrane assembly 30) depending on the speed, viscosity, heat capacity, and/or temperature gradient of a fluid moving inside the membrane assembly 30. In this case, an empirical equation that complements the theoretical value may be derived, based on experimental data, and be applied to the process.

Afterwards, the temperature of the wastewater W may be compared with a reference value in operation P400. For example, the reference value may be about 40° C. The disclosure is not limited thereto, and the reference value may be variously modified. When the temperature of the wastewater W is higher than or equal to the reference value, there is a risk of damage to the membrane assembly 30 and/or a pipe.

Based on the comparison of the temperature of the wastewater W and the reference value, the temperature of the absorbent liquid AL may be raised above the temperature of the wastewater W in operation P500. Operation P500 of raising the temperature of the absorbent liquid AL above the temperature of the wastewater W may include heating the absorbent liquid AL of operation P520 and/or cooling the wastewater W of operation P540.

Accordingly, when the temperature of the wastewater W is lower than the reference value, the absorbent liquid AL may be heated in operation P520. Conversely, when the temperature of the wastewater W is higher than the reference value, the wastewater W may be cooled in operation P540. The controller 50 may control the temperature of the wastewater W and/or the temperature of the absorbent liquid AL by controlling the first temperature adjuster 24 and/or the second temperature adjuster 44.

In the method of treating wastewater, according to one or more example embodiments, the movement of water vapor due to the difference between the mole fraction of water in the wastewater W and the mole fraction of water in the absorbent liquid AL may be at least partially compensated for by raising the temperature of the absorbent liquid AL above the temperature of the wastewater W. Accordingly, a method of treating wastewater with high reliability may be provided.

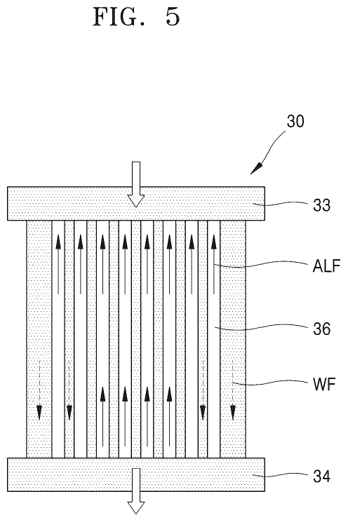

FIG. 5 is a diagram of the flows of wastewater and absorbent liquid in a membrane assembly according to one or more example embodiments. FIG. 5 is described with reference to FIGS. 1 to 3. In FIG. 5, WF denotes a direction in which wastewater W moves, and ALF denotes a direction in which absorbent liquid AL moves.

Referring to FIG. 5, wastewater W may flow from an upper portion 33 of a membrane assembly 30 to lower portion 34 thereof, and absorbent liquid AL may flow from the lower portion 34 of the membrane assembly 30 to the upper portion 33 thereof. In some embodiments, the wastewater W may flow from the lower portion 34 of the membrane assembly 30 to the upper portion 33 thereof, and the absorbent liquid AL may flow from the upper portion 33 of the membrane assembly 30 to the lower portion 34 thereof. When the direction in which the wastewater W moves is different from the direction in which the absorbent liquid AL moves inside the membrane assembly 30, impurities in the wastewater W may effectively diffuse into the absorbent liquid AL.

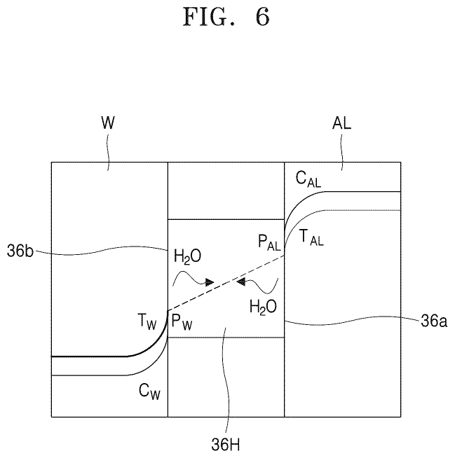

FIG. 6 is a diagram of the flow of water vapor in holes of a membrane according to one or more example embodiments. FIG. 6 is described with reference to FIGS. 1 to 4.

Referring to FIG. 6, absorbent liquid AL may contact an inner side surface 36a of a membrane 36, and wastewater W may contact an outer side surface 36b of the membrane 36. Impurities and water vapor of the wastewater W may move to the absorbent liquid AL inside a hole 36H of the membrane 36.

In FIG. 6, C_{W} and C_{AL} denote concentrations of salt in the wastewater W and the absorbent liquid AL, respectively. When the concentration of salt in the absorbent liquid AL is higher than the concentration of salt in the wastewater W, a mole fraction of water in the absorbent liquid AL may be lower than a mole fraction of water in the wastewater W. Accordingly, water vapor of the wastewater W may move to the absorbent liquid AL. The arrow located on the left of the holes 36H indicates a direction in which water vapor moves, which depends on a difference between the mole fraction of water in the wastewater W and the mole fraction of water in the absorbent liquid AL.

Also, a temperature of the absorbent liquid AL may be higher than a temperature of the wastewater W. Accordingly, water vapor of the absorbent liquid AL may move to the wastewater W. The arrow located on the right of the hole 36H indicates a direction in which water vapor moves, which depends on a difference between the temperature of the wastewater W and the temperature of the absorbent liquid AL.

Therefore, the movement of water vapor due to the difference between the mole fraction of water in the wastewater W and the mole fraction of water in the absorbent liquid AL inside the hole 36H may be at least partially offset by the movement of water vapor due to the difference between the temperature of the wastewater W and the temperature of the absorbent liquid AL.

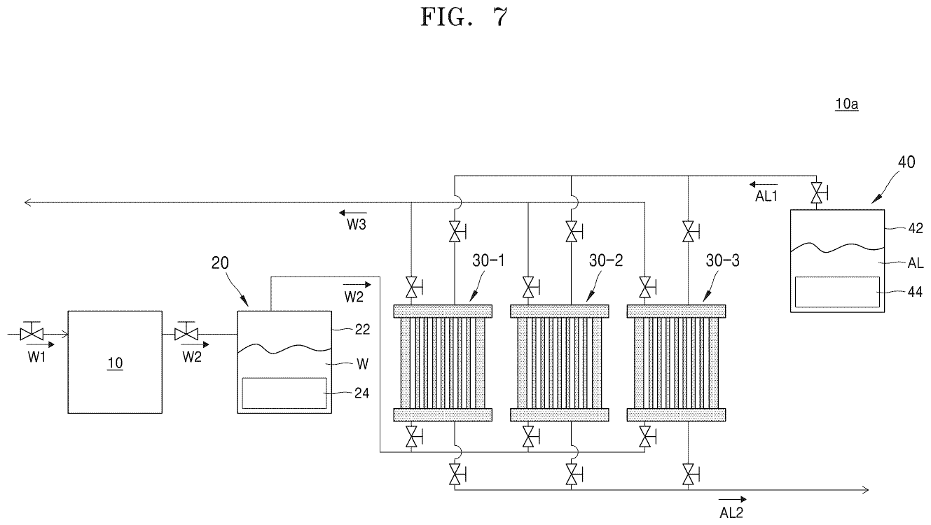

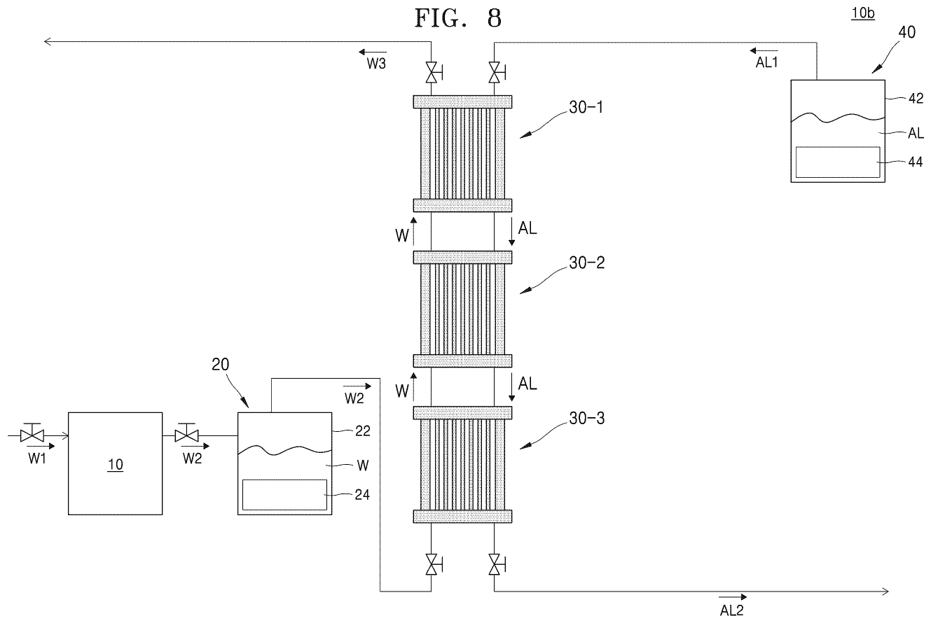

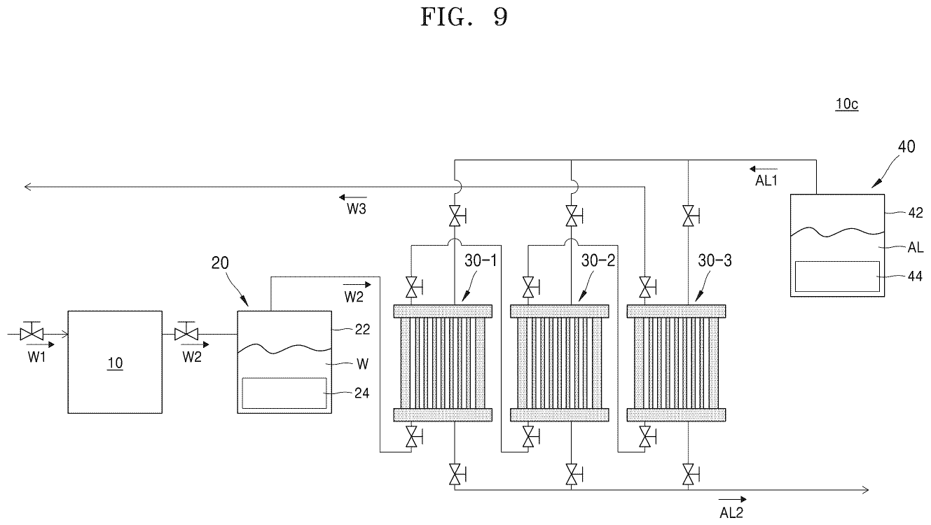

FIG. 7 is a diagram of a wastewater treating apparatus according to one or more example embodiments. FIG. 8 is a diagram of a wastewater treating apparatus according to one or more example embodiments. FIG. 9 is a diagram of a wastewater treating apparatus according to one or more example embodiments. The wastewater treating apparatuses of FIGS. 7 to 9 are described with reference to FIG. 1. In FIGS. 7 to 9, the illustration of the controller 50 is omitted for brevity.

Referring to FIG. 7, a wastewater treating apparatus 10a may include first to third membrane assemblies 30-1, 30-2, and 30-3, which are connected in parallel to each of a first water tank 20 and a second water tank 40. For example, the first to third membrane assemblies 30-1, 30-2, and 30-3 may receive wastewater W in parallel from the first water tank 20 and receive treated liquid AL in parallel from the second water tank 40. Because the first to third membrane assemblies 30-1, 30-2, and 30-3 are installed in parallel, the capacity of the wastewater W treated by the wastewater treating apparatus 10a may increase.

Referring to FIG. 8, a wastewater treating apparatus 10b may include first to third membrane assemblies 30-1, 30-2, and 30-3, which are connected in series to each of a first water tank 20 and a second water tank 40. For example, the first to third membrane assemblies 30-1, 30-2, and 30-3 may serially receive wastewater W from the first water tank 20 and serially receive treated liquid AL from the second water tank 40. Because the first to third membrane assemblies 30-1, 30-2, and 30-3 are installed in series, the impurity removal efficiency of the wastewater treating apparatus 10b may improve.

In FIG. 8, the wastewater W may move in the order of the third membrane assembly 30-3, the second membrane assembly 30-2, the first membrane assembly 30-1 in directions indicated by arrows, and the absorbent liquid AL may move in the order of the first membrane assembly 30-1, the second membrane assembly 30-2, and the third membrane assembly 30-3 in directions indicated by arrows.

Referring to FIG. 9, a wastewater treating apparatus 10c may include first to third membrane assemblies 30-1, 30-2, and 30-3, which are connected in series to a first water tank 20 and connected in parallel to a second water tank 40. For example, the first to third membrane assemblies 30-1, 30-2, and 30-3 may serially receive wastewater W from the first water tank 20 and receive treated liquid AL in parallel from the second water tank 40. Accordingly, the impurity removal efficiency of the wastewater treating apparatus 10c may improve.

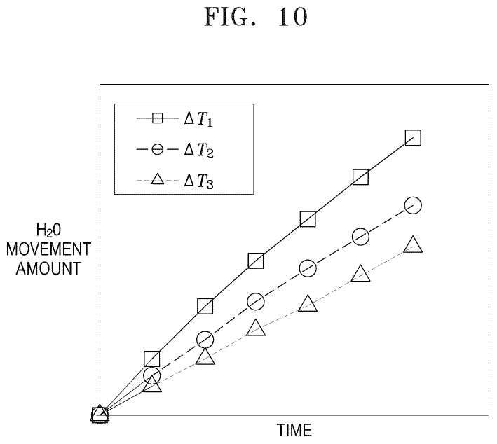

FIG. 10 is a graph showing the results of experiments using a method of treating wastewater, according to one or more example embodiments. FIG. 10 is described with reference to FIGS. 1 and 4. FIG. 10 illustrates an example in which the movement of water vapor due to a difference between a mole fraction of water in wastewater W and a mole fraction of water in absorbent liquid AL is dominant over the movement of water vapor due to a difference between a temperature of the wastewater W and a temperature of the absorbent liquid AL. In FIG. 10, the x-axis denotes an operating time of a wastewater treating apparatus 1, and the y-axis denotes the amount of water vapor (H₂O) moving from the wastewater W to the absorbent liquid AL. Each of the x-axis and the y-axis is indicated by an arbitrary unit (a.u.).

Referring to FIG. 10, each of ΔT₁, ΔT₂, and ΔT₃ denotes a temperature difference between the wastewater W and the absorbent liquid AL. As described above, a temperature of the absorbent liquid AL may be higher than or equal to a temperature of the wastewater W. ΔT₃ may be greater than each of ΔT₁ and ΔT₂, and ΔT₂ may be greater than ΔT₁. As a difference between the temperature of the wastewater W and the temperature of the absorbent liquid AL increases, the amount of water vapor moving from the wastewater W to the absorbent liquid AL may be reduced. Accordingly, by increasing the difference between the temperature of the wastewater W and the temperature of the absorbent liquid AL, the apparatus may compensate for the movement of water vapor due to a difference in mole fraction between water in the wastewater W and water in the absorbent liquid AL.

At least one of the devices, units, components, modules, units, or the like represented by a block or an equivalent indication in the above embodiments including, but not limited to, FIG. 1 may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

At least one of the devices, units, components, modules, units, or the like (collectively “devices”) represented by a block or an equivalent indication in the above embodiments including, but not limited to, the “controller 50” in FIG. 1, may be physically implemented by analog and/or digital circuits including one or more of a logic gate, an integrated circuit, a microprocessor, a microcontroller such as a CPU, a memory circuit, a passive electronic component, an active electronic component, an optical component, and the like, and the functions or operations of the devices may be implemented by or driven by software and/or firmware executed by the devices.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An apparatus configured to treat wastewater, the apparatus comprising:
a first water tank configured to store wastewater;
a second water tank configured to store absorbent liquid; and
a membrane assembly comprising a membrane comprising holes, the membrane assembly configured to:
receive the wastewater from the first water tank and the absorbent liquid from the second water tank,
wherein the membrane assembly is further configured to allow materials to move between the wastewater and the absorbent liquid through the holes, and
wherein, in the membrane assembly, a temperature of the absorbent liquid is different from a temperature of the wastewater.

2. The apparatus of claim 1, wherein the wastewater comprises at least one of ammonia and hydrogen fluoride.

3. The apparatus of claim 2, wherein, when the wastewater comprises ammonia, the absorbent liquid is acidic, and
wherein, when the wastewater comprises hydrogen fluoride, the absorbent liquid is basic.

4. The apparatus of claim 1, wherein the membrane comprises at least one of tetrafluroethylene hexafluoropropylene (FEP), perfluoroalkyl alkylvinyl-ether (PFA), ethylene-tetrafluoroethylene (ETFE), polyvinylidene fluoride (PVDF), polytetrafluoroethylene (PTFE), polyethylene (PE), polypropylene (PP), polyether ether ketone (PEEK), polyarylsulfone (PSU), polyethersulphone (PES), polyimide (PI), and polybenzimidazole (PBI), and
wherein the membrane has hydrophobic surface characteristics.

5. The apparatus of claim 1, further comprising at least one of:
a first temperature adjuster comprising at least one of a heater and a cooler, the first temperature adjuster configured to change the temperature of the wastewater; and
a second temperature adjuster comprising at least one of a heater and a cooler, the second temperature adjuster configured to change the temperature of the absorbent liquid.

6. The apparatus of claim 1, wherein the membrane assembly further comprises an inlet port for the wastewater, an outlet port for the wastewater, an inlet port for the absorbent liquid, and an outlet port for the absorbent liquid,
wherein the outlet port for the wastewater and the inlet port for the absorbent liquid are adjacent and on an upper portion of the membrane assembly, and
wherein the inlet port for the wastewater and the outlet port for the absorbent liquid are adjacent and on a lower portion of the membrane assembly.

7. The apparatus of claim 1, further comprising a hydrogen peroxide treating tank connected to the first water tank, the hydrogen peroxide treating tank configured to remove hydrogen peroxide in the wastewater.

8. The apparatus of claim 7, wherein the hydrogen peroxide treating tank comprises a catalyst configured to promote a hydrogen peroxide decomposition reaction.

9. An apparatus configured to treat wastewater, the apparatus comprising:
a first water tank configured to store wastewater;
a second water tank configured to store absorbent liquid;
at least one membrane assembly comprising a membrane comprising holes, the at least one membrane assembly configured to:
receive the wastewater from the first water tank the absorbent liquid from the second water tank, wherein the at least one membrane assembly is further configured to allow materials to move between the wastewater and the absorbent liquid through the holes;
a first temperature adjuster configured to change a temperature of the wastewater;
a second temperature adjuster configured to change a temperature of the absorbent liquid; and
a controller configured to control the temperature of the absorbent liquid to be higher than the temperature of the wastewater by controlling at least one of the first temperature adjuster and the second temperature adjuster.

10. The apparatus of claim 9, wherein the at least one membrane assembly further comprises an inlet port for the wastewater, an outlet port for the wastewater, inlet port for the absorbent liquid, and an outlet port for the absorbent liquid, and
wherein the apparatus further comprises:
a first thermometer provided at a front end of the inlet port for the wastewater;
a second thermometer provided at a rear end of the outlet port for the wastewater;
a third thermometer provided at a front end of the inlet port for the absorbent liquid; and
a fourth thermometer provided at a rear end of the outlet port for the absorbent liquid.

11. The apparatus of claim 10, wherein the controller is configured to control the first temperature adjuster or the second temperature adjuster, based on a measured value of at least one of the first thermometer, the second thermometer, the third thermometer, and the fourth thermometer.

12. The apparatus of claim 10, wherein the controller is further configured to:
determine the temperature of the wastewater as an average of a measured value of the first thermometer and a measured value of the second thermometer, and
determine the temperature of the absorbent liquid as an average of a measured value of the third thermometer and a measured value of the fourth thermometer is measured.

13. The apparatus of claim 12, wherein the first temperature adjuster is provided the first water tank, and the second temperature adjuster is provided the second water tank.

14. The apparatus of claim 9, wherein the at least one membrane assembly comprises a plurality of membrane assemblies, and
wherein the plurality of membrane assemblies are connected in series to the first water tank and are connected in parallel to the second water tank.

15. The apparatus of claim 9, wherein a mole fraction of water in the wastewater is higher than a mole fraction of water in the absorbent liquid.

16. A method of treating wastewater using a membrane assembly, the method comprising:
measuring a temperature of wastewater and a temperature of absorbent liquid;
determining a mole fraction of water in the wastewater and a mole fraction of water in the absorbent liquid;
determining a difference between a vapor pressure of the wastewater and a vapor pressure of the absorbent liquid based on the mole fraction of water in the wastewater and the mole fraction of water in the absorbent liquid;
determining the temperature for absorbent liquid based on the difference between the vapor pressure of the wastewater and the vapor pressure of the absorbent liquid; and
raising the temperature of the absorbent liquid above the temperature of the wastewater based on the determined temperature for the absorbent liquid.

17. The method of claim 16, wherein the raising of the temperature of the absorbent liquid above the temperature of the wastewater comprises:
cooling the wastewater based on the temperature of the wastewater being lower than a reference value; and
heating the absorbent liquid based on the temperature of the wastewater being higher than the reference value.

18. The method of claim 16, wherein measuring the temperature of the wastewater and the temperature of the absorbent liquid comprises determining an average of the temperature of the wastewater and the temperature of the absorbent liquid,
wherein the temperature of the wastewater and the temperature of the absorbent liquid are measured at a front end and a rear end of the membrane assembly.

19. The method of claim 16, wherein a direction in which the wastewater moves in the membrane assembly is different from a direction in which the absorbent liquid moves in the membrane assembly.

20. The method of claim 16, wherein a concentration of salt in the absorbent liquid is higher than a concentration of salt in the wastewater.
